(19) United States
(12) Patent Application Publication
(10) Pub. No.: US 2014/0123317 A1
(43) Pub. Date: May 1, 2014

(54) CONFIDENTIAL INFORMATION MANAGEMENT SYSTEM

(71) Applicant: KYOCERA Document Solutions Inc., Osaka (JP)

(72) Inventor: Hiroshi Sugihara, Osaka (JP)

(73) Assignee: KYOCERA Document Solutions Inc., Osaka (JP)

(21) Appl. No.: 14/057,765

(22) Filed: Oct. 18, 2013

(30) Foreign Application Priority Data
Oct. 26, 2012 (JP) 2012-237323

(51) Int. Cl. G06F 21/62; G06F 21/31

(52) U.S. Cl. CPC G06F 21/62; G06F 21/31
USPC 726/28

(57) ABSTRACT

A confidential information management system includes an entry control apparatus, an information storage unit, an electronic apparatus, and an access control unit. The electronic apparatus includes a user authentication unit that decides whether a user is authorized to log in in the electronic apparatus, and a communication unit communicable with a mobile terminal of the user. The access control unit registers, when the user authentication unit permits the user to log in in the electronic apparatus, the mobile terminal to communicate with the communication unit, and decides whether the mobile terminal is permitted to access confidential information in the information storage unit. The access control unit also validates the registration of the mobile terminal of the user permitted to log in in the electronic apparatus while the entry control apparatus recognizes that the user is in the controlled area, and permits the mobile terminal to access the confidential information.

### INCORPORATION BY REFERENCE

This application claims priority to Japanese Patent Application No. 2012-237323 filed on 26 Oct. 2012, the entire contents of which are incorporated by reference herein.

### BACKGROUND

1. Technical Field

The present disclosure relates to a confidential information management system, and more particularly to a technique to permit viewing or printing of information represented by an electronized document only in a controlled area, to thereby secure the confidentiality of the information.

2. Related Art

With the recent spread of electronization of documents, a huge amount of electronized documents are accumulated in information storage devices, and those electronized documents are freely accessible for viewing or printing at a desired location. While the electronization of documents has provided greater convenience in utilizing the documents, an important issue has arisen concerning secrecy management of confidential information that has to be concealed, such as the electronized documents, drawings, photos, and so forth. Restricting the access to the confidential information is one of effective measures of the secrecy management. However, even though the access is restricted, the risk of information leakage still remains since a user who has the right to access can view or print the confidential information at a desired location.

Therefore, some techniques have been proposed to permit the user to view or print the confidential information only in a controlled area where the entry and exit of the user are controlled, thus to restrict the user from taking out the confidential information. An example of such techniques is a management system that permits a user to view the confidential information only by a terminal apparatus installed in a controlled area.

### SUMMARY

In an aspect, the disclosure proposes improvement of the foregoing technique.

The disclosure provides a confidential information management system including an entry control apparatus, an information storage unit, an electronic apparatus, and an access control unit.

The entry control apparatus controls entry and exit of a user to and from a controlled area.

The information storage unit stores therein confidential information access to which is restricted.

The electronic apparatus is located in the controlled area, and includes a user authentication unit that decides whether the user is authorized to log in in the electronic apparatus, and a communication unit communicable with a mobile terminal carried by the user.

The access control unit registers, when the user authentication unit permits the user to log in in the electronic apparatus, the mobile terminal to communicate with the communication unit, and decides whether the registered mobile terminal is permitted to access the confidential information stored in the information storage unit.

The access control unit also validates the registration of the mobile terminal carried by the user permitted to log in in the electronic apparatus while the entry control apparatus recognizes that the user permitted to log in is in the controlled area, and permits the registered mobile terminal to access the confidential information.

### BRIEF DESCRIPTION OF THE DRAWINGS

FIG. 1 is a schematic block diagram showing a general configuration of a confidential information management system according to an embodiment of the disclosure.

FIGS. 2A and 2B represent examples of an entry control table according to the embodiment of the disclosure.

FIG. 3 is a functional block diagram showing an essential internal configuration of an image forming apparatus according to the embodiment of the disclosure.

FIGS. 4A and 4B represent examples of a terminal management table according to the embodiment of the disclosure.

FIG. 5 is a flowchart showing a confidential information management process performed by the confidential information management system according to the embodiment of the disclosure.

### DETAILED DESCRIPTION

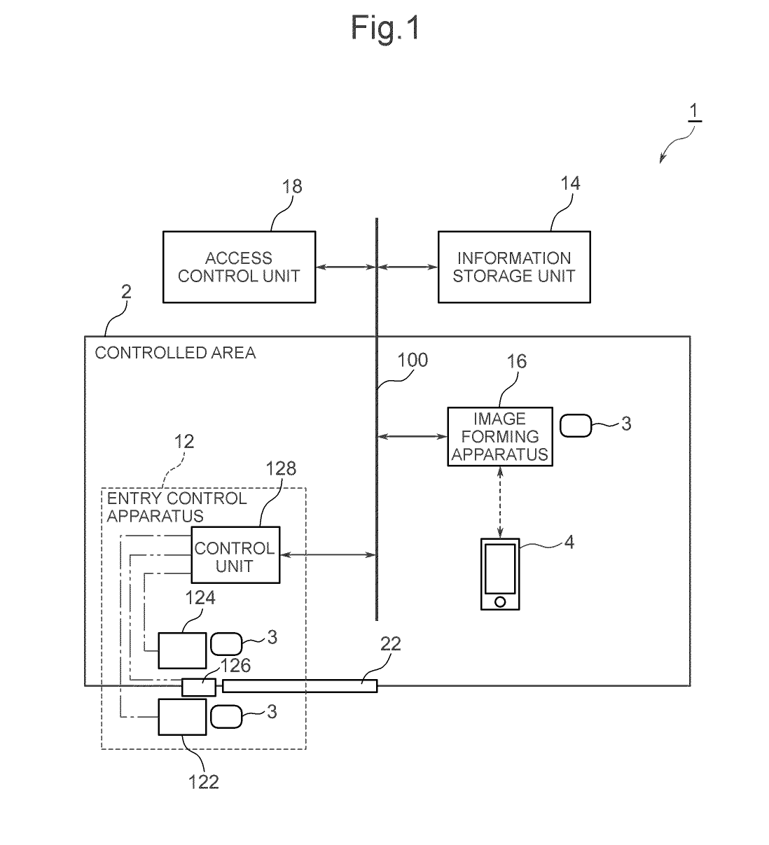

Hereafter, a confidential information management system according to an embodiment of the disclosure will be described referring to the drawings. FIG. 1 is a schematic block diagram showing a general configuration of the confidential information management system according to the embodiment of the disclosure.

The confidential information management system 1 according to this embodiment permits access to the confidential information, for example printing or viewing thereof, only in a controlled area 2 in order to prevent the confidential information the access to which is restricted, such as documents, drawings, photos and so forth, from being accidentally accessed and taken out.

The confidential information management system 1 includes an entry control apparatus 12, an information storage unit 14, an image forming apparatus 16, and an access control unit 18. These are communicably connected to one another through a network 100, for example a local area network (LAN).

The information storage unit 14 stores therein the confidential information, and may be exemplified by a file server. The confidential information stored in the information storage unit 14 is only accessible by a user authorized to access through a process controlled by the access control unit 18 as will be subsequently described.

As shown in FIG. 1, the information storage unit 14 is installed in another location, for example a server room under a strict security control, apart from the controlled area 2. Alternatively, the information storage unit 14 may be installed in the controlled area 2, or incorporated in the image forming apparatus 16 as a constituent thereof, instead of utilizing a file server as the information storage unit 14.

The entry control apparatus 12 controls the entry and exit of the user to and from the controlled area 2. The entry control apparatus 12 includes an entry card reader 122, an exit card reader 124, an electric lock 126 for the door 22 of the controlled area 2, and a control unit 128.

The door 22 of the controlled area 2 is ordinarily locked by the electric lock 126. The electric lock 126 electrically controls the locking and unlocking of the door 22, and may be exemplified by a solenoid electric lock having a movable core, a stator core, a coil, and so forth.

The entry card reader 122 is located outside the controlled area 2. When the user brings an ID card 3 closely opposite the entry card reader 122 for entering the controlled area 2, the entry card reader 122 reads the ID information of the user from the ID card 3, and transmits the ID information to the control unit 128. The control unit 128 unlocks the electric lock 126 in the case where the control unit 128 decides on the basis of the ID information that the user is authorized to enter the controlled area 2, and locks the electric lock 126 after a predetermined time has elapsed.

The ID card 3 is set up for non-contact authentication, for example by radio frequency identification (RFID). Here, the user authentication method may additionally employ a password, in addition to the ID card 3.

When the user is to leave the controlled area 2, the user brings the ID card 3 closely opposite the exit card reader 124 located inside the controlled area 2. Then the exit card reader 124 reads out the user's ID information from the ID card 3, and transmits the ID information to the control unit 128. The control unit 128 unlocks the electric lock 126 in the case where the control unit 128 decides on the basis of the ID information that the user is authorized to leave the controlled area 2, and locks the electric lock 126 after a predetermined time has elapsed.

The control unit 128 receives the ID information from the card readers 122, 124, decides on the basis of the ID information whether the user is authorized to enter or leave the controlled area 2, locks and unlocks the electric lock 126, and stores therein the user's history of the entry and exit to and from the controlled area 2. More specifically, the control unit 128 contains an entry control table in a non-illustrated database, and records the user's history of the entry and exit to and from the controlled area 2 on the entry control table.

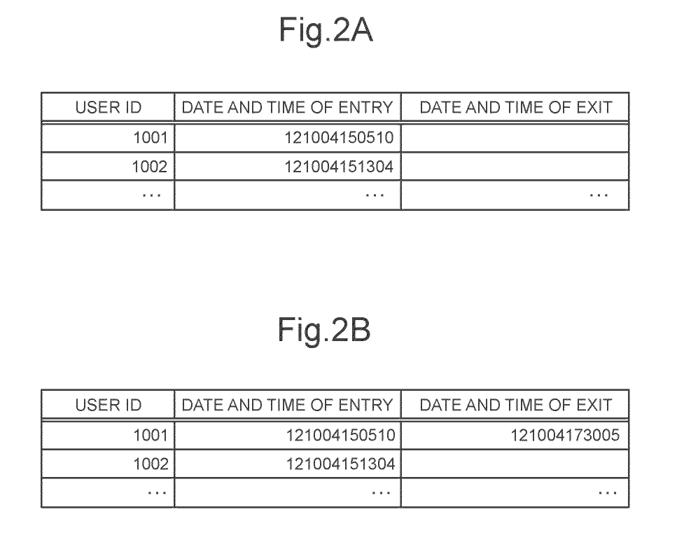

FIGS. 2A and 2B each represent an example of the entry control table. FIG. 2A represents an example of the entry control table recorded when the user enters the controlled area 2. The entry control table shown in FIG. 2A indicates that a user having the ID of “1001” and a user having the ID of “1002” entered the controlled area 2 at 15:05:10 on Oct. 4, 2012 (date and time of entry “121004150510”), and at 15:13:04 on Oct. 4, 2012 (date and time of entry “121004151304”), respectively. In this entry control table, the date and time of exit is regarded as “null” (no information) while the users of the ID “1001” and “1002” are in the controlled area 2.

FIG. 2B represents an example of the entry control table recorded after the user has left the controlled area 2. This entry control table indicates that the user of the ID “1001” left the controlled area 2 at 17:30:05 on Oct. 4, 2012 (date and time of exit “121004173005”). Thus, when the user leaves the controlled area 2 the control unit 128 records the date and time of exit of the user in the field of “date and time of exit” of the same record.

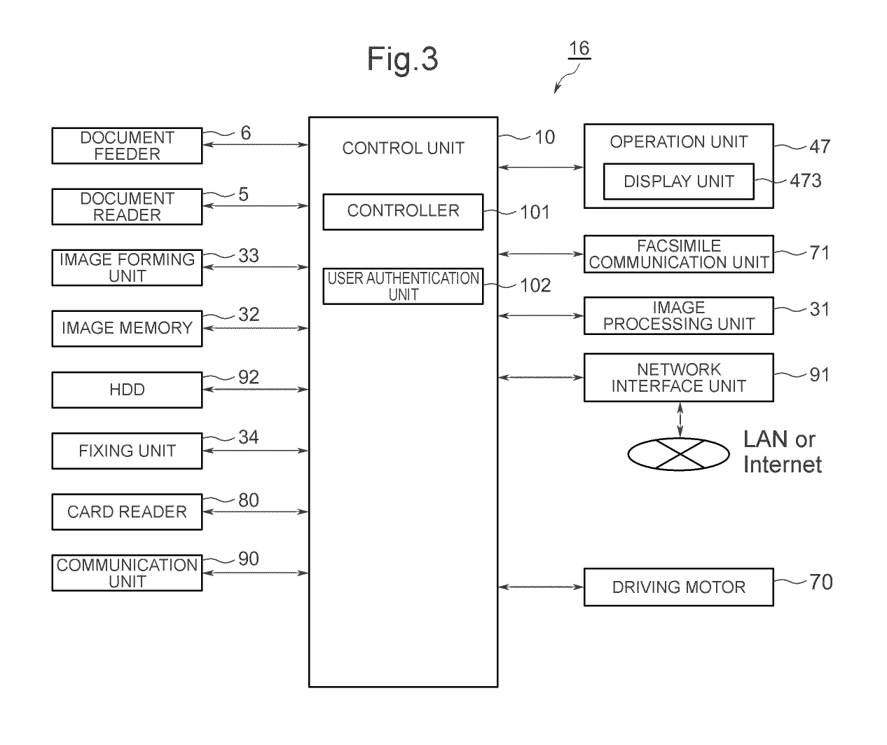

Referring again to FIG. 1, the image forming apparatus 16 is a multifunction machine having functions of, for example, a copier, a printer, a scanner, and a facsimile machine. The image forming apparatus 16 includes a card reader 80 (see FIG. 3), so that the card reader 80 reads out the user's ID information from the ID card 3 when the user brings the ID card 3 closely opposite the card reader 80, and transmits the ID information to a user authentication unit 102 (see FIG. 3). The user authentication unit 102 decides on the basis of the ID information whether the user is a legitimate user authorized to operate the image forming apparatus 16, and permits the user to log in in the image forming apparatus 16 in the case where the user is decided to be a legitimate user. Here, the ID card 3 used for logging in is the identical ID card 3 used for entry and exit to and from the controlled area 2 (see FIG. 1).

The image forming apparatus 16 also has a function to provide a hotspot® for wireless communication. A mobile terminal 4 carried by a log-in user can be connected to the image forming apparatus 16 through the hotspot®. The mobile terminal 4 maybe exemplified a PDA, a tablet PC, and the like. The log-in user is authorized to view confidential information stored in the information storage unit 14 through the mobile terminal 4 under a predetermined condition.

FIG. 3 is a functional block diagram showing an essential internal configuration of the image forming apparatus 16. The image forming apparatus 16 includes a control unit 10, an operation unit 47, a document feeder 6, a document reader 5, an image processing unit 31, an image memory 32, an image forming unit 33, a fixing unit 34, a driving motor 70, a facsimile communication unit 71, a network interface unit 91, a hard disk drive (HDD) 92, a card reader 80, and a communication unit 90.

The control unit 10 is composed of a central processing unit (CPU), RAM, ROM, an exclusive hardware circuit and so forth, and serves to control the overall operation of the image forming apparatus 16. The control unit 10 includes a controller 101 and a user authentication unit 102.

The controller 101 is connected to the operation unit 47, the document feeder 6, the document reader 5, the image processing unit 31, the image memory 32, the image forming unit 33, the fixing unit 34, the driving motor 70, the facsimile communication unit 71, the network interface unit 91, the HDD 92, the card reader 80, and the communication unit 90, to control the operation of those components.

The user authentication unit 102 decides, on the basis of the user's ID information acquired from the ID card 3 by the card reader 80, whether the user is authorized to use the image forming apparatus 16 and, in the affirmative case, admits the user as a log-in user and permits the user to operate the image forming apparatus 16.

The document reader 5 includes a reading mechanism composed of a light emitter, a CCD sensor, and so forth that are under the control of the control unit 10. When the image forming apparatus 16 reads a source document, the document reader 5 emits light from the light emitter to the source document, delivered from the document feeder 6 or placed on a glass document table, and receives the reflected light with the CCD sensor to thereby read the image of the source document.

The image processing unit 31 processes the data of the image read by the document reader 5 as needed. For example, the image processing unit 31 performs a predetermined image processing such as shading, to improve the quality of the image formed by the image forming unit 33 on the basis of the image read by the document reader 5.

The image memory 32 is a region where image data of the source document read by the document reader 5, and data to be printed by the image forming unit 33 are temporarily stored.

The image forming unit 33 forms the image of the print data read by the document reader 5, print data received from the information storage unit 14 (see FIG. 1) connected through the network, and so forth.

The operation unit 47 receives instructions of an operator for various operations and processes to be executed by the image forming apparatus 16. The operation unit 47 includes a display unit 473.

The facsimile communication unit 71 includes a non-illustrated encoding/decoding unit, a modulation/demodulation unit, and a network control unit (NCU), and transmits a facsimile through a public phone network.

The network interface unit 91 includes a communication module such as a LAN board, and transmits and receives various data to and from the information storage unit 14 (see FIG. 1) in the local area through the LAN connected to the network interface unit 91.

The HDD 92 is a storage medium having a large capacity for storing the images of the source documents and so on read by the document reader 5.

The fixing unit 34 fixes the image formed by the image forming unit 33 on a recording sheet by heat and pressure.

The driving motor 70 is a driving source that supplies rotational driving force to rotary components and transport roller pairs of the image forming unit 33.

The card reader 80 reads out from the ID card 3 for entry and exit to and from the controlled area 2 (see FIG. 1) the ID information of the user who is the owner of the ID card 3, and transmits the ID information to the control unit 10. In the control unit 10, the user authentication unit 102 executes the user authentication as described above.

The communication unit 90 provides a hotspot® set up according to a near-field wireless communication system such as Wi-Fi® or Bluetooth®. The communication unit 90 can establish a session with the mobile terminal 4 according to a request therefrom, to thereby communicate with the mobile terminal.

Back again to FIG. 1, the access control unit 18 registers the mobile terminal 4 that has established the session with the communication unit 90, when the user authentication unit 102 of the image forming apparatus 16 permits the user to log in in the image forming apparatus 16.

The access control unit 18 validates the registration of the mobile terminal 4 carried by the log-in user when the entry control apparatus 12 recognizes that the log-in user is in the controlled area 2, and permits the mobile terminal 4 registered to access the confidential information stored in the information storage unit 14.

Further, the access control unit 18 cancels the registration of the mobile terminal 4 upon receipt of a notice from the entry control apparatus 12 to the effect that the log-in user has left the controlled area 2. The access control unit 18 thus disables the mobile terminal 4 from accessing the confidential information at a later time. In other words, the access control unit 18 controls whether to permit the mobile terminal 4 to access the confidential information. To be more detailed, the access control unit 18 contains a terminal management table in a non-illustrated database, and records the registration of the mobile terminal 4 on the terminal management table as a terminal permitted to access the confidential information, and permits only the recorded mobile terminal 4 to access the confidential information stored in the information storage unit 14.

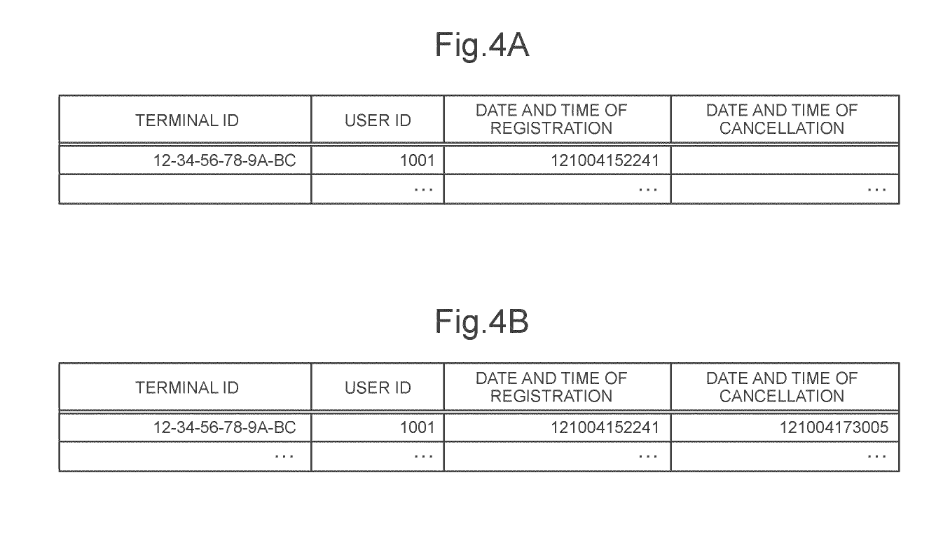

FIGS. 4A and 4B represent examples of the terminal management table. FIG. 4A represents an example of the terminal management table recorded when the mobile terminal 4 carried by the log-in user is registered. The terminal management table shows that the terminal ID “12-34-56-78-9A-BC” of the mobile terminal 4 is recorded in association with the user ID “1001”, and that the mobile terminal 4 was registered at 15:22:41 on Oct. 4, 2012 (date and time of registration “121004152241”). Here, the terminal ID is the identification code exclusive to the mobile terminal 4 and, for example, represented by a MAC address or a Bluetooth address.

FIG. 4B represents an example of the terminal management table recorded when the log-in user left the controlled area 2. The terminal management table shows that the registration of the mobile terminal 4 having the terminal ID “12-34-56-78-9A-BC” was cancelled at 17:30:05 on Oct. 4, 2012 (date and time of cancellation “121004173005”). The access control unit 18 cancels the registration of the mobile terminal 4 of the user who has left the controlled area 2, upon receipt of the information indicating the ID of the user and the date and time of exit, from the entry control apparatus 12. The access control unit 18 records the date and time of exit in the field of “date and time of cancellation” in all the records corresponding to the user ID on the terminal management table, upon receipt of the information indicating the ID of the user who left the controlled area and the date and time of exit, from the entry control apparatus 12. The date and time of cancellation in the example shown in FIG. 4B agree with the date and time of exit shown in FIG. 2B.

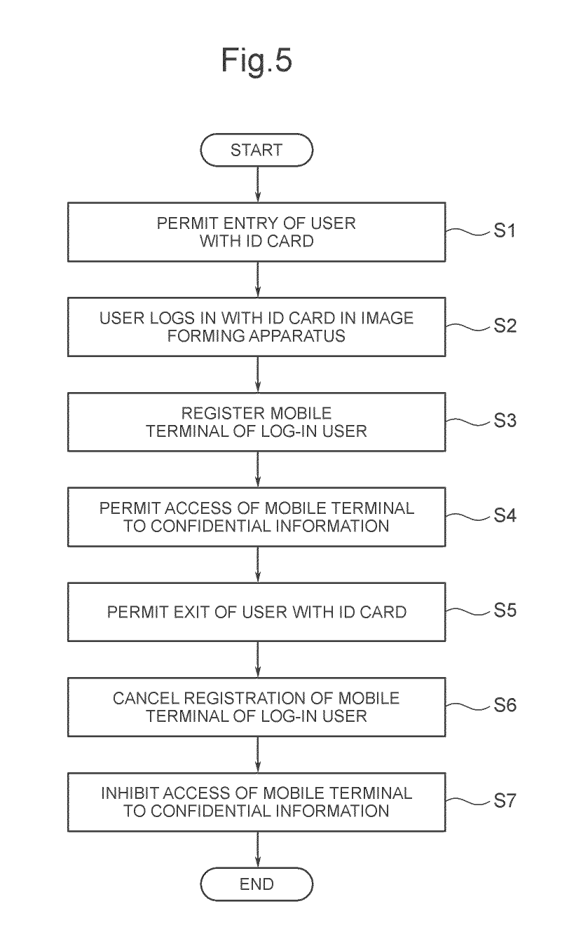

Hereunder, the confidential information management performed by the confidential information management system 1 will be described. FIG. 5 is a flowchart showing the confidential information management process performed by the confidential information management system 1.

The user brings the ID card 3 closely opposite the entry card reader 122 when entering the controlled area 2. The entry card reader 122 reads out the ID information of the user from the ID card 3, and transmits the ID information to the control unit 128. The control unit 128 unlocks the electric lock 126 in the case where the control unit 128 decides on the basis of the ID information that the user is authorized to enter the controlled area 2 (S1). Accordingly, the user can open the door 22 and enter the controlled area 2.

The user who has entered the controlled area 2 again uses the ID card 3 to log in in the image forming apparatus 16 (S2). To be more detailed, when the user brings the ID card 3 closely opposite the card reader 80, the card reader 80 reads out from the ID card 3 the ID information of the user who is the owner of the ID card 3, and transmits the ID information to the control unit 10. The user authentication unit 102 in the control unit 10 decides whether the user is authorized to use the image forming apparatus 16 on the basis of the ID information, and recognizes the user as the log-in user and permits the user to operate the image forming apparatus 16, in the case where the user is decided to be an authorized user.

The communication unit 90 of the image forming apparatus 16 establishes a session with the mobile terminal 4 carried by the log-in user, in the case where the communication unit 90 receives a request for registration of the mobile terminal 4 of the log-in user, inputted by the log-in user through the operation unit 47 of the image forming apparatus 16. The access control unit 18 registers the mobile terminal 4 as a terminal permitted to access the confidential information (S3).

Then the access control unit 18 permits the mobile terminal 4 to access the confidential information stored in the information storage unit 14 (S4). In this process, for example, a control unit in the information storage unit 14 permits, according to a request from the browser incorporated in the mobile terminal 4, the access to the requested document among the documents stored in the information storage unit 14, thereby enabling the mobile terminal 4 to view the document.

Thereafter, the user leaves the controlled area 2 by using the ID card 3. When the user brings the ID card 3 closely opposite the exit card reader 124 located inside the controlled area 2, the exit card reader 124 reads out the ID information of the user from the ID card 3, and transmits the ID information to the control unit 128. The control unit 128 unlocks the electric lock 126 upon deciding on the basis of the ID information that the user is authorized to leave the controlled area 2 (S5). Thus, the user can open the door 22 and leave the controlled area 2.

At this point, the access control unit 18 receives the notice from the entry control apparatus 12 to the effect that the user has left the controlled area 2, and cancels the registration of the mobile terminal 4 carried by the user (S6). The access control unit 18 then inhibits subsequent access to the confidential information by the mobile terminal 4 of the log-in user (S7). Therefore, the user can no longer view the document stored in the information storage unit 14 by using the mobile terminal 4.

Here, the access control unit 18 may cancel the registration of the mobile terminal 4 when the log-in user logs off from the image forming apparatus 16. In this case, the mobile terminal 4 is registered as a terminal permitted to access the confidential information, each time the user logs in in the image forming apparatus 16. Accordingly, even though the mobile terminal 4 has once been registered, the access to the confidential information by that mobile terminal is restricted depending on whether the user having the mobile terminal has logged in in the image forming apparatus 16, in other words depending on the use of the access right by the log-in user. Such an arrangement allows the access to the confidential information by the mobile terminal 4 to be strictly controlled, thereby enabling the confidentiality of the confidential information to be surely secured, without compromising the convenience in handling the confidential information.

As described thus far, in this embodiment the image forming apparatus 16 is installed in the controlled area 2, and the mobile terminal 4 carried by the log-in user of the image forming apparatus 16 is communicable with the communication unit 90 of the image forming apparatus 16. The access control unit 18 registers the mobile terminal 4 of the log-in user staying in the controlled area 2 as a terminal permitted to access the confidential information stored in the information storage unit 14 and the access to which is restricted, and the mobile terminal 4 thus registered is permitted to access the confidential information.

The configuration according to the embodiment allows, therefore, the mobile terminal 4 that has been registered to access the confidential information stored in the information storage unit 14, thereby improving the convenience in handling the confidential information with the mobile terminal 4 in the controlled area 2. In addition, since the access control unit 18 permits access to the confidential information only by the mobile terminal 4 of the log-in user present in the controlled area 2 and permitted to log in, the confidential information can be prevented from being accidentally taken out by the mobile terminal 4 and thus the confidentiality of the confidential information can be secured.

Here, the management system may adopt, for example, a procedure including registering the mobile terminals of the respective users in advance of the access to the confidential information, and permitting each of the mobile terminals registered in advance to access the confidential information. However, registering the mobile terminals in the management system in advance of the access to the confidential information is troublesome and unpractical because each user owns a different mobile terminal, and besides a single user may own a plurality of mobile terminals and utilize a different mobile terminal each time the user is to access the confidential information. In this aspect, according to the registration of the mobile terminal and handling of the confidential information by the access control unit 18 according to the foregoing embodiment, the mobile terminal 4 is registered when the user is about to access the confidential information. Therefore, the management system according to the embodiment enables a wide variety of mobile terminals to access the confidential information thereby securing sufficient convenience, and at the same time surely secures the confidentiality of the confidential information.

According to the embodiment, the access control unit 18 cancels the registration of the mobile terminal 4 of the log-in user of the image forming apparatus 16 when the log-in user leaves the controlled area 2. Therefore, although the mobile terminal 4 is still able to communicate with the image forming apparatus 16 from outside the controlled area 2 after the log-in user has left the controlled area 2, the mobile terminal 4 is inhibited from accessing the confidential information, and thus an accidental access to the confidential information by the mobile terminal 4 can be prevented.

According to the embodiment, further, the ID information read out from the identical ID card 3 is employed for the entry control apparatus 12 to decide whether to permit the entry and exit of the user, and for the image forming apparatus 16 to decide whether to permit the user to log in. Therefore, the user can utilize the identical ID card 3 in all the cases of entering the controlled area 2, logging in in the image forming apparatus 16, and accessing the confidential information by using the mobile terminal 4, which provides significant convenience to the user.

Further, according to the embodiment the access control unit 18 records the time when the mobile terminal 4 of the user was registered and the time when the registration was cancelled on the terminal management table in a recording apparatus. Therefore, a system administrator can discover an access suspected to be unauthorized to the confidential information, for example in the case where the registration of the mobile terminal 4 is not cancelled for a long time, by reviewing the terminal management table recorded in the recording apparatus.

When the access control unit 18 permits the registered mobile terminal 4 to access the confidential information, the access control unit 18 may only permit the mobile terminal 4 to view the confidential information, inhibiting the storing. Such an arrangement imposes more strict restriction on the takeout of the confidential information by the mobile terminal 4.

Instead, the access control unit 18 may also permit the registered mobile terminal 4 to store the confidential information, and set an expiration time for the stored confidential information. Such an arrangement disables the user from accessing the confidential information after a predetermined period of time has elapsed despite the user having taken out the confidential information from the controlled area 2, thereby effectively preventing the leakage or diffusion of the confidential information.

With the popularization of the mobile terminals such as personal digital assistants (PDA) and smartphones, the electronized documents are coming to be more often viewed on such mobile terminal, than being printed on a paper medium. Accordingly, there has been a growing demand for viewing the confidential information accessible only in the controlled area on the mobile terminal carried by the user. To meet the demand, a management system has been proposed that allows the user to view the confidential information only on a terminal apparatus installed in the controlled area. However, since such a management system permits the user to view the confidential information only on a specific exclusive terminal apparatus, only a limited number of users can view the confidential information.

In contrast, the confidential information management system 1 according to the foregoing embodiment includes the entry control apparatus 12, the information storage unit 14, the image forming apparatus 16, and the access control unit 18, and is therefore capable of allowing the user to access the confidential information in the controlled area with the user's mobile terminal, thereby improving the convenience of use, and also capable of preventing the confidential information from being accidentally taken out by the mobile terminal, thus surely securing the confidentiality of the confidential information.

The contents of the disclosure may be modified in various manners without limitation to the foregoing embodiment. For example, although the electronic apparatus is exemplified by the image forming apparatus 16 in the embodiment, a different electronic apparatus such as an information display unit or an information processing unit may be employed. Further, even when the image forming apparatus 16 is employed, the image forming apparatus is not limited to the foregoing multifunction machine, but may be a different image forming apparatus such as a printer, a copier, a facsimile machine or the like.

It is to be understood that the configurations and procedures according to the embodiment described as above referring to FIGS. 1 to 5 are merely exemplary of the disclosure, and not intended to limit the contents of the disclosure to the foregoing configurations and procedures.

Various modifications and alterations of the disclosure will be apparent to those skilled in the art without departing from the scope and spirit of the disclosure, and it should be understood that the disclosure is not limited to the illustrative embodiments set forth herein.

What is claimed is:

1. A confidential information management system comprising:
an entry control apparatus that controls entry and exit of a user to and from a controlled area;
an information storage unit that stores therein confidential information access to which is restricted;
an electronic apparatus located in the controlled area and including a user authentication unit that decides whether the user is authorized to log in in the electronic apparatus, and a communication unit communicable with a mobile terminal carried by the user; and
an access control unit that registers, when the user authentication unit permits the user to log in in the electronic apparatus, the mobile terminal to communicate with the communication unit, and decides whether the registered mobile terminal is permitted to access the confidential information stored in the information storage unit,
wherein the access control unit validates the registration of the mobile terminal carried by the user permitted to log in in the electronic apparatus while the entry control apparatus recognizes that the user permitted to log in is in the controlled area, and permits the registered mobile terminal to access the confidential information.

2. The confidential information management system according to claim 1,
wherein the access control unit permits, upon permitting the registered mobile terminal to access the confidential information, the mobile terminal to view the confidential information and inhibits the mobile terminal from storing the confidential information.

3. The confidential information management system according to claim 1,
wherein the access control unit further permits the registered mobile terminal to store the confidential information, and sets an expiration time for the confidential information upon permitting the registered mobile terminal to store the confidential information.

4. The confidential information management system according to claim 1,
wherein the access control unit cancels the registration of the mobile terminal upon receipt of a notice from the entry control apparatus to the effect that the user permitted to log in has left the controlled area.

5. The confidential information management system according to claim 1,
wherein the access control unit cancels the registration of the mobile terminal, when the user permitted to log in logs off from the electronic apparatus.

6. The confidential information management system according to claim 1,
wherein the entry control apparatus and the electronic apparatus each include an ID card reader, and
ID information read out from the identical ID card is employed for the entry control apparatus to decide whether to permit entry and exit of the user, and for the electronic apparatus to decide whether to permit the user to log in.

7. The confidential information management system according to claim 1,
wherein the access control unit records a time when the mobile terminal was registered and a time when the registration was cancelled, in a recording apparatus.
